(19) United States
(12) Patent Application Publication
(10) Pub. No.: US 2014/0293468 A1
(43) Pub. Date: Oct. 2, 2014

(54) APODIZATION FILTER AND METHOD OF MANUFACTURING THE SAME

(71) Applicant: COSINA CO., LTD., Nakano-shi (JP)

(72) Inventors: Masayuki MIKAMI, Nakano-shi (JP); Kazuo KIMURA, Nakano-shi (JP); Hirofumi KOBAYASHI, Nakano-shi (JP)

(73) Assignee: COSINA CO., LTD., Nakano-shi (JP)

(21) Appl. No.: 14/203,672

(22) Filed: Mar. 11, 2014

(30) Foreign Application Priority Data
Apr. 1, 2013 (JP) 2013-075830

(51) Int. Cl. G02B 5/20

(52) U.S. Cl. CPC G02B 5/205
USPC 359/888; 427/164

(57) ABSTRACT

A light-blocking mask layer (3) having such light transmittance characteristics that an amount of transmitted light decreases gradually as it advances in a radial direction Fr from a center of optical axis Cs is formed on a surface of a flat transparent substrate at least having a light transmittance of 80% or higher using at least a dot pattern Pd formed of a large number of dots d, having a light transmittance of 20% or lower.

### TECHNICAL FIELD

The present invention relates to an apodization filter having such light transmittance characteristics that the amount of transmitted light decreases gradually as it advances in a radial direction from the center of optical axis and a method of manufacturing the apodization filter.

### BACKGROUND ART

In general, although a blur occurs when a camera lens is at a defocus position, it cannot be said that a clean blur is always formed because an edge effect occurs in an edge of a captured image. For example, an imaged dot appears as a so-called ring blur having a donut shape and an imaged single line appears as a so-called double-line blur having two lines. Due to this, an apodization filter having such light transmittance characteristics that the amount of transmitted light decreases gradually as it advances in a radial direction from the center of optical axis is inserted in an optical path of a camera lens so that a smooth and natural blur is formed.

Conventionally, an apodization filter used in an imaging lens system disclosed in Patent Literatures 1 and 2 is known as an example of the apodization filter used for such purposes. This apodization filter is formed as a planar filter with no power by bonding a planoconcave lens made from an ND glass and a planoconvex lens made from a glass having the same refractive index as the ND glass so that the amount of transmitted light decreases gradually as it advances in a perpendicular direction from the center of optical axis.

### SUMMARY OF INVENTION

### Technical Problem

However, the conventional apodization filter described above has the following problems.

A first problem is that, because the apodization filter is formed by bonding a planoconcave lens and a planoconvex lens, the apodization filter has to have a certain thickness, and there is a limit in obtaining a thin apodization filter. As a result, the apodization filter inserted in a camera lens causes contradictory drawbacks that an increase in an overall lens length in the optical axis direction incurs an increase in the size of the camera lens, whereas preventing the increase in the size makes it difficult to obtain a satisfactory blur effect. Moreover, since the apodization filter requires two lens components having the same accuracy as general lenses, an increase in the cost is unavoidable. Further, a limited degree of freedom in lens design incurs a decrease in functions and performance of lenses.

A second problem is that it is not possible to obtain a light transmittance of 100% at the center of optical axis due to the structure of the apodization filter. That is, since the planoconcave lens needs to have light reducing properties, it is not possible to decrease the thickness at the center of the planoconcave lens to zero. As a result, it is not possible to obtain a light transmittance of 100% at the center, and a loss of the amount of transmitted light is unavoidable.

An object of the present invention is to provide an apodization filter and a method of manufacturing the same that can solve the problems of the background art.

### Solution to Problem

In order to solve the above-described problems, an apodization filter according to the present invention is an apodization filter having such light transmittance characteristics that an amount of transmitted light decreases gradually as it advances in a radial direction from a center of optical axis, wherein a light-blocking mask layer having such light transmittance characteristics that an amount of transmitted light decreases gradually as it advances in a radial direction from a center of optical axis is formed on a surface of a flat transparent substrate at least having a light transmittance of 80% or higher using at least a dot pattern formed of a large number of dots, having a light transmittance of 20% or lower.

In order to solve the above-described problems, a method of manufacturing an apodization filter according to the present invention is a method of manufacturing an apodization filter having such light transmittance characteristics that an amount of transmitted light decreases gradually as it advances in a radial direction from a center of optical axis, including: preparing a flat transparent substrate at least having a light transmittance of 80% or higher; and forming a light-blocking mask layer having such light transmittance characteristics that an amount of transmitted light decreases gradually as it advances in a radial direction from a center of optical axis on a surface of the transparent substrate at least having a light transmittance of 80% or higher using at least a dot pattern formed of a large number of dots, having a light transmittance of 20% or lower.

### Advantageous Effects of Invention

According to the apodization filter and the method of manufacturing the same according to the present invention, the following remarkable advantageous effects are obtained.

(1) Since the apodization filter is formed by forming the light-blocking mask layer having such light transmittance characteristics that the amount of transmitted light decreases gradually as it advances in the radial direction from the center of optical axis on the surface of the flat transparent substrate using the dot pattern formed of a large number of dots, an overall filter thickness is approximately the same as the thickness of the flat transparent substrate. Thus, it is possible to easily obtain a very thin apodization filter and to decrease the size and weight of the camera lens. Further, since substantially one transparent substrate is enough as a component required, it is possible to obtain the apodization filter at a very low cost.

(2) Since the apodization filter uses the dot pattern formed of a large number of dots, it is possible to freely change the pattern design to increase the degree of freedom in lens design and to further improve the functions and performance of the lens. As a result, it is possible to secure an optimized satisfactory blur effect regardless of an overall filter thickness and to easily create various light transmittance characteristics. Further, an appropriate stretch can be caused to occur toward the outer side from the edge positions at the ends of a captured image and a light transmittance of 100% can be obtained at the center and the vicinities thereof Thus, it is possible to obviate a loss of the amount of transmitted light.

(3) The method of manufacturing the apodization filter includes: preparing the flat transparent substrate at least having a light transmittance of 80% or higher; and forming the light-blocking mask layer having such light transmittance characteristics that the amount of transmitted light decreases gradually as it advances in the radial direction from the center of optical axis on the surface of the transparent substrate using at least the dot pattern formed of a large number of dots, having a light transmittance of 20% or lower. Thus, it is possible to easily manufacture the apodization filter at a low cost.

(4) As a preferred embodiment, if the number of dots in at least a circle region having a predetermined radius about the center of optical axis in the light-blocking mask layer is set to zero, by selecting (changing) the area of the circle region, it is possible to change and optimize the loss of the amount of transmitted light.

(5) As a preferred embodiment, if a width of the dots is selected in a range of 50 μm to 500 μm, it is possible to obtain the apodization filter having a satisfactory blur effect from practical perspectives. That is, a too small width of the dots incurs manufacturing limitations (in terms of cost or the like) and a too large width Wd of the dots d makes it difficult to obtain a satisfactory blur effect. However, by selecting the width of the dots in the range of 50 μm to 500 μm, these drawbacks can be avoided.

(6) As a preferred embodiment, if the dots are selected to have the same shape and size, the amount of transmitted light can be changed in a digital manner by changing the density of the random distribution.

(7) As a preferred embodiment, if a frosted black color is selected as the color of the dots, it is possible to prevent adverse and useless reflection.

(8) As a preferred embodiment, the process of forming the light-blocking mask layer may include at least any one of a thin film forming process, an ink jet printing process, or a silk printing process. That is, when the apodization filter is manufactured, various forming techniques including general methods can be applied. Thus, it is possible to provide satisfactory flexibility and convenience of manufacturing processes and to dramatically reduce the manufacturing cost.

### BRIEF DESCRIPTION OF DRAWINGS

FIG. 1 is a cross-sectional side view including an enlarged view of a portion of an apodization filter according to a preferred embodiment of the present invention.

FIG. 2 is a principle side view illustrating an example of a camera lens that uses the apodization filter.

FIG. 3 is a front view including enlarged views of portions of the apodization filter.

FIG. 4 is a graph illustrating a light transmittance distribution of the apodization filter.

FIG. 5 is a principle side view illustrating another example of a camera lens that uses the apodization filter.

FIG. 6 is a flowchart illustrating an example of a method of manufacturing the apodization filter.

FIG. 7A is a cross-sectional side view illustrating an intermediate product of an apodization filter in a manufacturing step of the manufacturing method.

FIG. 7B is a cross-sectional side view illustrating an intermediate product of an apodization filter in another manufacturing step of the manufacturing method.

FIG. 7C is a cross-sectional side view illustrating an intermediate product of an apodization filter in another manufacturing step of the manufacturing method.

FIG. 7D is a cross-sectional side view illustrating an intermediate product of an apodization filter in another manufacturing step of the manufacturing method.

### DESCRIPTION OF EMBODIMENTS

Hereinafter, a preferred embodiment of the present invention will be described in detail based on the drawings. The accompanying drawings are not intended to restrict the present invention but are intended to make the present invention better understood. Moreover, well-known portions will not be described in detail in order to make the present invention understood clearly.

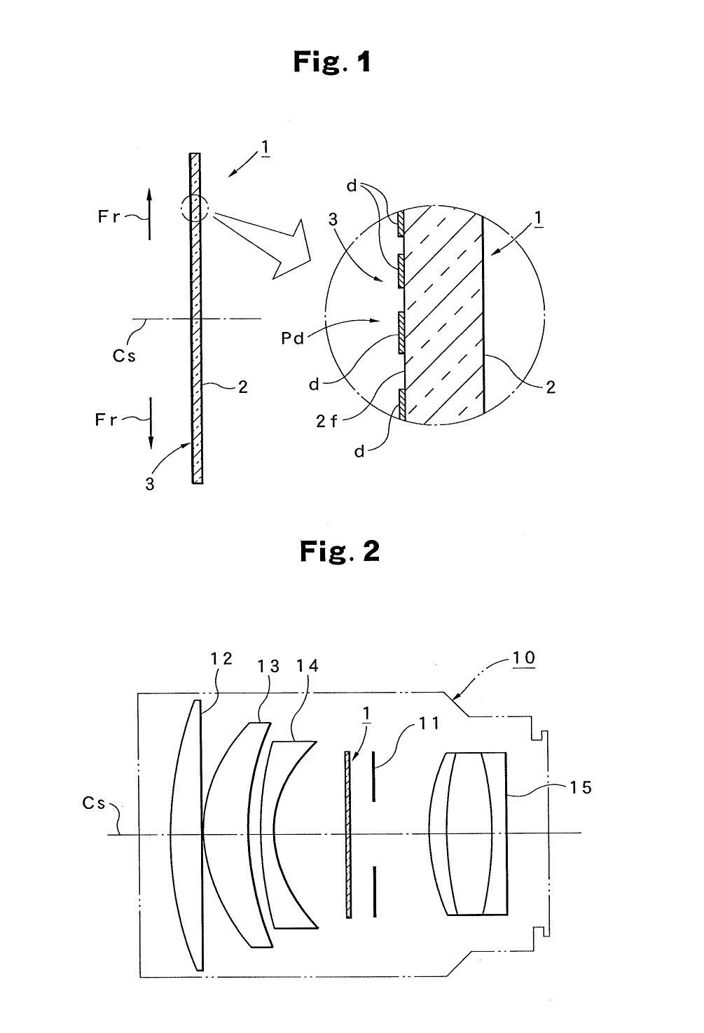

First, the configuration and usage of an apodization filter 1 according to the present embodiment will be described with reference to FIGS. 1 to 5. The embodiment illustrates a case where a glass plate 2 is used as a transparent substrate.

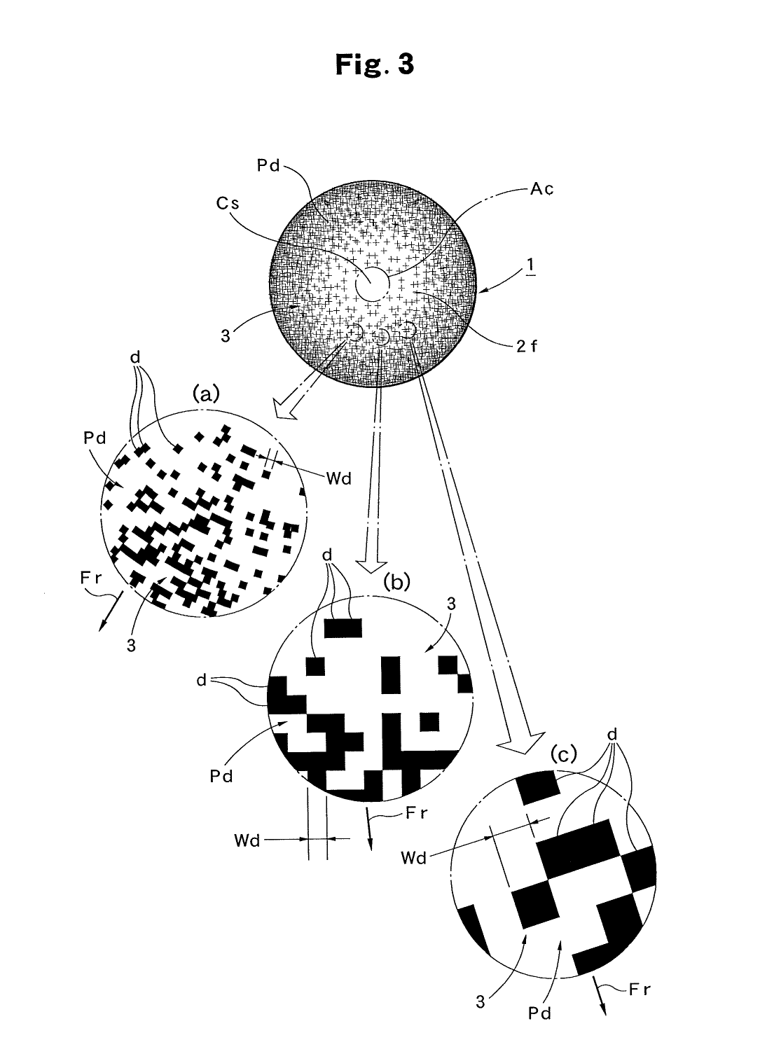

The apodization filter 1 has a basic configuration in which a light-blocking mask layer 3 having such light transmittance characteristics that an amount of transmitted light decreases gradually as it advances in a radial direction Fr from the center of optical axis Cs as illustrated in FIG. 3 is formed on a surface 2f of a flat glass plate 2.

In this case, the glass plate 2 is a plate glass having a thickness of approximately 1 mm, of which the front and rear surfaces are parallel, and for example, an optical glass or the like used in a lens can be used as a material. The glass plate 2 may basically be a transparent glass having a light transmittance of approximately 100% and may have other filter functions (ND filter function or the like) other than an apodization filter. However, even in this case, a glass plate having a light transmittance of 80% or higher is selected in order to secure an apodization effect.

Meanwhile, the light-blocking mask layer 3 uses a dot pattern Pd formed of a large number of dots d. Preferably, the dots d have a black color, for example, and are in a frosted state in order to prevent adverse and useless reflection. Although the light transmittance is preferably 0%, since an object is to obtain such light transmittance characteristics that the amount of transmitted light decreases gradually as it advances in the radial direction Fr from the center of optical axis Cs, the light transmittance does not need to be 0% exactly but may be 20% or lower.

The large number of dots d are arranged randomly so that the above-described light transmittance characteristics that the amount of transmitted light decreases gradually as it advances in the radial direction Fr from the center of optical axis Cs is obtained. Since the respective dots d have the same shape and size, the amount of transmitted light can be changed in a digital manner by changing the density of the random distribution. Thus, the above-described light transmittance characteristics are set according to the distribution density of the large number of dots d. In this case, as illustrated in FIG. 3, the number of dots d in at least a circle region Ac having a predetermined radius about the center of optical axis Cs, of the light-blocking mask layer 3 (the dot pattern Pd) is set to zero. In this way, by selecting (changing) the area of the circle region Ac, it is possible to obtain an advantage that a loss of the amount of transmitted light can be changed and optimized.

Further, a width Wd of the dots d is selected in the range of 50 μm to 500 μm. FIGS. 3A, 3B, and 3C illustrate examples of the dot pattern when the width Wd of the dots d is changed. FIG. 3A illustrates a case (sample A) where squares of 100 μm by 100 μm are arranged in parallel in the radial direction, FIG. 3B illustrates a case (sample B) where squares of 250 μm by 250 μm are arranged with horizontal and vertical directions fixed, and FIG. 3C illustrates a case (sample C) where squares of 500 μm by 500 μm are arranged in parallel in the radial direction.

Table 1 illustrates the light transmittances T [%] at a distance r [mm] from the center of the apodization filter 1 based on these samples A, B, and C. The light transmittances T are values calculated according to T=exp(s*(r−p)̂2) (where, r>p). In this case, “s” and “p” are parameters that give a light transmittance distribution in an exponential curve. It is assumed that T=1 if r≦p. In Table 1, all test samples A to C have a configuration in which a chrome (Cr) coating is formed on the surface of a transparent plate glass having a thickness of 1 mm and a radius of 13 mm to form dots d. Thus, the light transmittance of the dots d is approximately 0%.

TABLE 1

| | | Light transmittance T | | |
|---|---|---|---|---|
| | | Sample | | |
| | | A | B | C |
| | | s | | |
| | | −0.023 | −0.035 | −0.058 |
| p | | 1.0 | 3.0 | 5.0 |
| Distance | r (mm) | | | |
| from | 0.5 | 1.0000 | 1.0000 | 1.0000 |
| center | 1.0 | 1.0000 | 1.0000 | 1.0000 |
| | 1.5 | 0.9943 | 1.0000 | 1.0000 |
| | 2.0 | 0.9773 | 1.0000 | 1.0000 |
| | 2.5 | 0.9496 | 1.0000 | 1.0000 |
| | 3.0 | 0.9121 | 1.0000 | 1.0000 |
| | 3.5 | 0.8661 | 0.9913 | 1.0000 |
| | 4.0 | 0.8130 | 0.9656 | 1.0000 |
| | 4.5 | 0.7545 | 0.9243 | 1.0000 |
| | 5.0 | 0.6921 | 0.8694 | 1.0000 |
| | 5.5 | 0.6277 | 0.8035 | 0.9856 |
| | 6.0 | 0.5627 | 0.7298 | 0.9436 |
| | 6.5 | 0.4987 | 0.6513 | 0.8777 |
| | 7.0 | 0.4369 | 0.5712 | 0.7929 |
| | 7.5 | 0.3784 | 0.4923 | 0.6959 |
| | 8.0 | 0.3240 | 0.4169 | 0.5933 |
| | 8.5 | 0.2742 | 0.3469 | 0.4914 |
| | 9.0 | 0.2295 | 0.2837 | 0.3953 |
| | 9.5 | 0.1898 | 0.2279 | 0.3090 |
| | 10.0 | 0.1552 | 0.1800 | 0.2346 |
| | 10.5 | 0.1255 | 0.1396 | 0.1730 |
| | 11.0 | 0.1003 | 0.1065 | 0.1239 |
| | 11.5 | 0.0792 | 0.0798 | 0.0863 |
| | 12.0 | 0.0619 | 0.0587 | 0.0583 |
| | 12.5 | 0.0478 | 0.0425 | 0.0383 |

As obvious from Table 1, a light transmittance T of 100% is obtained at the center and the vicinities thereof and a loss of the amount of transmitted light can be avoided. Moreover, a light transmittance T of approximately 10% to 12% as intended can be obtained near the periphery located at a distance of 11 mm from the center. By forming the light-blocking mask layer 3 having the dot pattern Pd formed of the large number of dots d on the surface 2f of the flat glass plate 2 in this manner, it is possible to obtain light transmittance characteristics that provide such an apodization effect that the amount of transmitted light decreases gradually as it advances in the radial direction Fr from the center of optical axis Cs.

In this way, by selecting the width Wd of the dots d in the range of 50 μm to 500 μm, it is possible to obtain the apodization filter 1 having a satisfactory blur effect from practical perspectives. That is, a too small width Wd of the dots d incurs manufacturing limitations (in terms of cost or the like) and a too large width Wd of the dots d makes it difficult to obtain a satisfactory blur effect. However, by selecting the width Wd of the dots d in the range of 50 μm to 500 μm, these drawbacks can be avoided.

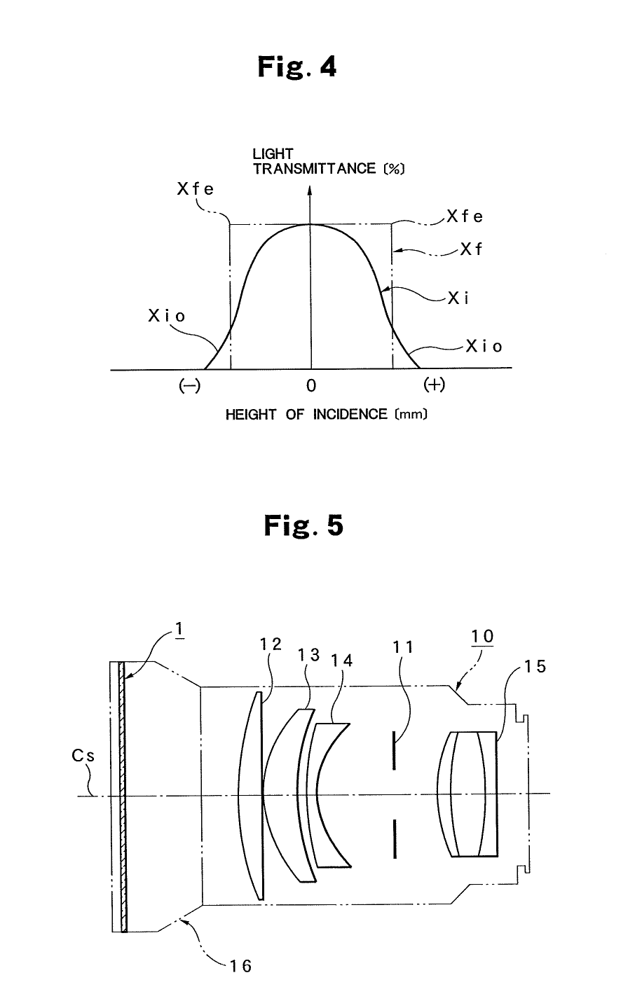

The apodization filter 1 having such a configuration can be built into the camera lens 10 similarly to the conventional apodization filter as illustrated in FIG. 2. In the illustrated example, the apodization filter 1 is disposed near (in front of) an aperture 11. In the camera lens 10, reference numerals 12, 13, 14, and 15 are lenses or lens groups. If the distance between the apodization filter 1 and a film (captured image) is tens of millimeters [mm], λ is a wavelength, “a” is the size of a dot-shaped space in a portion of the dot pattern Pd where the dots d are not present, and the size of the dot-shaped space “a” is 50 μm to 100 μm, an appropriate stretch can be caused to occur in the captured image from a relational expression sin θ=λ/a. That is, as illustrated in FIG. 4, if Xfe indicated by an imaginary line is an edge position of a captured image Xf in a normal focus state and the apodization filter 1 in which the size of the dot-shaped space a is selected in the range of 50 μm to 100 μm is interposed, an appropriate stretch Xio can be caused to occur toward the outer side from the edge positions Xfe as in the captured image Xi indicated by a solid line in FIG. 4. In this case, since the smaller the width Wd of the dots d, the smaller the size of the dot-shaped space a can be made, it is possible to increase the stretch Xio.

As described above, according to the apodization filter 1 according to the present embodiment, since the light-blocking mask layer 3 having such light transmittance characteristics that the amount of transmitted light decreases gradually as it advances in the radial direction Fr from the center of optical axis Cs on the surface 2f of the flat glass plate 2 using the dot pattern Pd formed of a large number of dots d, an overall filter thickness is approximately the same as the thickness of the flat glass plate 2. Thus, it is possible to easily obtain a very thin apodization filter and to decrease the size and weight of the camera lens. Further, since substantially one glass plate is enough as a component required, it is possible to obtain the apodization filter at a very low cost. Moreover, since the dot pattern Pd formed of a large number of dots d is used, it is possible to freely change the pattern design to increase the degree of freedom in lens design and to further improve the functions and performance of the lens. As a result, it is possible to secure an optimized satisfactory blur effect regardless of an overall filter thickness and to easily create various light transmittance characteristics. Further, an appropriate stretch can be caused to occur toward the outer side from the edge positions at the ends of a captured image and a light transmittance of 100% can be obtained at the center and the vicinities thereof. Thus, it is possible to obviate a loss of the amount of transmitted light.

In particular, since the size and weight of the apodization filter 1 can be decreased, the apodization filter 1 may be arranged in front of the camera lens 10 as illustrated in FIG. 5. In this case, the apodization filter 1 is attached to a large hood 16, and the hood 16 is configured to be back-attached or detachably attached. When this embodiment is applied to the camera lens 10 of a telescopic system, it is expected that a constant apodization effect is obtained. In the other configuration of FIG. 5, the same components as those of FIG. 2 are denoted by the same reference numerals to clarify the configuration.

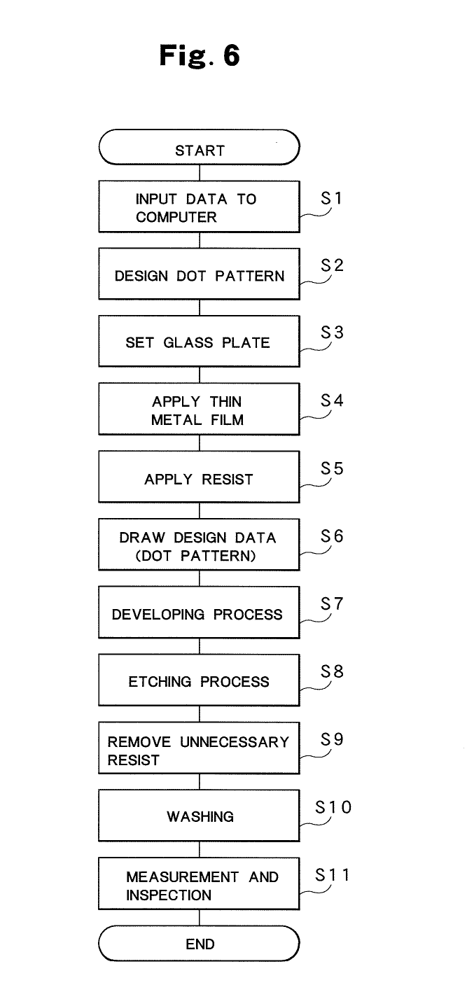

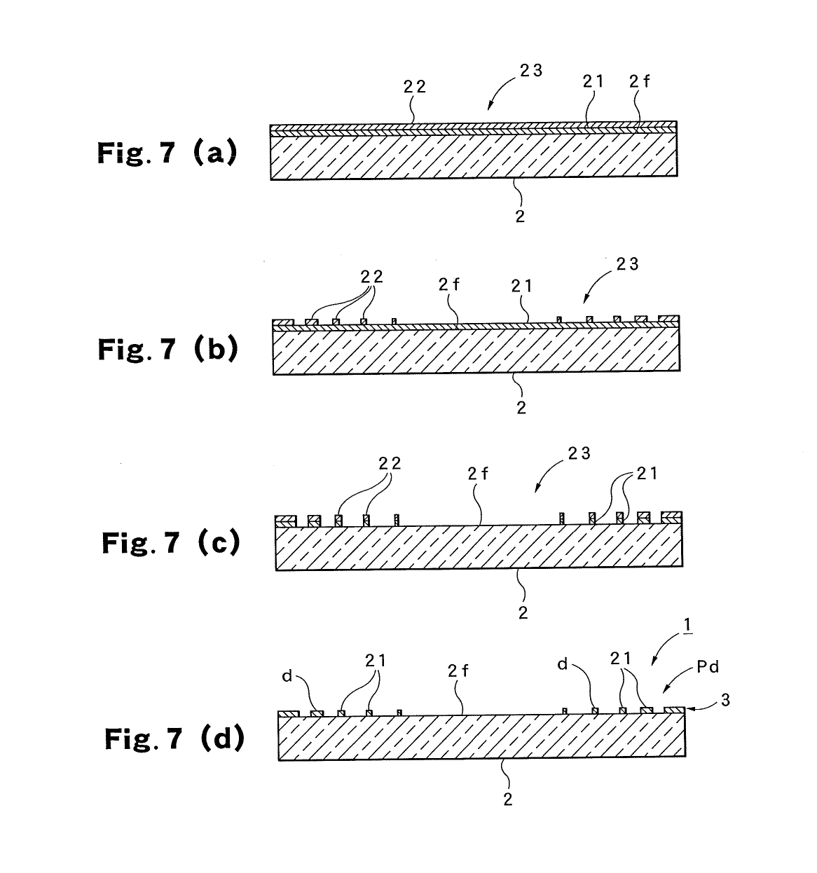

Next, an example of a method of manufacturing the apodization filter 1 according to the present embodiment will be described with reference to FIG. 6 and FIGS. 7A to 7D.

In the manufacturing method illustrated in FIG. 6 and FIGS. 7A to 7D, a thin film forming process is used in the process of forming the light-blocking mask layer 3. Moreover, since the dot pattern Pd has such light transmittance characteristics that the amount of transmitted light decreases gradually as it advances in the radial direction Fr from the center of optical axis Cs, the dot pattern Pd having such light transmittance characteristics can be automatically designed based on known data such as data associated with the camera lens and the shape, size, and the like of the dots d. Thus, in the illustrated example, it is assumed that an application program that realizes such an automatic design is created in advance.

Here, a case of manufacturing the apodization filter 1 used in the camera lens 10 illustrated in FIG. 2 is assumed. First, known data such as data associated with the camera lens 10 and the shape, size, and the like of the dots d is input (or selected) to a design computer such as CAD (step S1). The design computer automatically designs an intended dot pattern Pd (step S2).

A flat glass plate 2 at least having a light transmittance of 80% or higher is prepared, and the glass plate 2 is set at a predetermined position of a manufacturing system (step S3). As an example, the glass plate 2 is a transparent plate glass having a thickness of 1 mm and a radius of 13 mm, of which the front and rear surfaces are parallel. Subsequently, as illustrated in FIG. 7A, a thin metal film 21 using a metal material (chrome or the like) is applied to the surface (upper surface) 2f of the glass plate 2 (this application may include various attachment means such as deposition). A material at least having a light transmittance of 20% lower is selected as the thin metal film 21. Further, a resist (photosensitizer) 22 is applied to the thin metal film 21 (steps S4 and S5). In this way, a glass substrate 23 serving as a raw material is obtained. Subsequently, a laser beam is emitted to the upper surface of the glass substrate 23 from a perpendicular direction to draw the designed dot pattern Pd (setting data) (step S6).

Moreover, when the drawing of the dot pattern Pd ends, a developing process is performed to remove the resist 22 in portions other than the dot pattern Pd (step S7). FIG. 7B illustrates the glass substrate 23 in which the resist 22 is removed. Subsequently, an etching process is performed to remove the thin metal film 21 corresponding to the portion of the glass substrate 23 in which the resist 22 is removed (step S8). FIG. 7C illustrates the glass substrate 23 after the etching process. When the etching process ends, all unnecessary portions of the resist 22 on the glass substrate 23 are removed (step S9). This state is illustrated in FIG. 7D.

After that, the glass substrate 23 is washed, and the positions, sizes, and the like of the thin metal film 21 corresponding to the dot pattern Pd formed on the surface 2f of the glass plate 2 are measured to check whether the measured values are identical to normal data, and inspections such as visual inspection are performed to check whether scratches or the like are present (steps S10 and S11). By the above steps, it is possible to obtain the intended apodization filter 1 (see FIG. 7D). That is, it is possible to obtain the apodization filter 1 in which the light-blocking mask layer 3 based on the thin metal film 21 having the shape of the dot pattern Pd is formed on the surface (upper surface) 2f of the glass plate 2.

Although an example of using a thin film forming process when forming the light-blocking mask layer 3 has been illustrated, the light-blocking mask layer 3 may be formed using an ink jet printing process or a silk printing process. In particular, when the dots d are relatively large, the light-blocking mask layer 3 can be formed relatively easily using a silk printing process. When accuracy and strength are required, the thin film forming process is appropriate. The method of forming the light-blocking mask layer 3 can be appropriately selected according to the grade, the required accuracy, and the like of the apodization filter 1.

As described above, the method of manufacturing the apodization filter 1 according to the present embodiment includes: preparing the flat glass plate 2 at least having a light transmittance of 80% or higher; and forming the light-blocking mask layer 3 having such light transmittance characteristics that the amount of transmitted light decreases gradually as it advances in the radial direction Fr from the center of optical axis Cs on the surface 2f of the glass plate 2 using at least the dot pattern Pd formed of a large number of dots d, having a light transmittance of 20% or lower. Thus, it is possible to easily manufacture the intended apodization filter 1 at a low cost. Moreover, according to the method of manufacturing the apodization filter 1 according to the present embodiment, the process of forming the light-blocking mask layer 3 may include at least any one of a thin film forming process, an ink jet printing process, and a silk printing process. That is, when the apodization filter 1 is manufactured, various forming techniques including general methods can be applied. Thus, it is possible to provide satisfactory flexibility and convenience of manufacturing processes and to dramatically reduce the manufacturing cost.

While preferred embodiments have been described in detail, the present invention is not limited to these embodiments, specific configurations, shapes, materials, numbers, and the like can be optionally changed, added, and deleted without departing from the spirit of the present invention.

For example, although the width Wd of the dots d is preferably selected in the range of 50 μm to 500 μm, the width is not always limited to this range. For example, when highly accurate dots d having a width of less than 50 μm can be easily formed using a forming technique, the dots d having the width of less than 50 μm may be used. Moreover, when the present invention is applied to a large-size camera that uses a large (large-aperture) camera lens, the dots d having a width Wd exceeding 500 μm can be used. Further, although a case where the dots d have a square shape has been illustrated, various other shapes including polygonal shapes and simple shapes such as a circular shape, an elliptical shape, or a linear shape can be used. In particular, examples of a linear shape include a circular arc shape having a certain length in a circumferential direction and a straight line shape having a certain length in a radial direction. Although a thin film forming process, an ink jet printing process, and a silk printing process have been mentioned as examples of the process of forming the light-blocking mask layer 3, other forming processes can be also used. Further, although a glass plate 2 has been illustrated as an example of the transparent substrate, other transparent substrates such as a plastic plate may also be used by appropriately selecting the forming process. Thus, the plate of the transparent substrate is a concept that includes a sheet and a film as well as a hard plate such as a glass plate.

### INDUSTRIAL APPLICABILITY

The apodization filter according to the present invention can be used for creating a satisfactory blur effect by using the same in an optical system (lens system) of a still camera, a video camera, and the like.

### REFERENCE SIGNS LIST

1: Apodization filter, 2: Glass plate (Transparent substrate), 2f: Surface of glass plate (Transparent substrate), 3: Light-blocking mask layer, Cs: Center of optical axis, Fr: Radial direction, d: Dot, Pd: Dot pattern, Ac: Circle region, Wd: Dot width

### CITATION LIST

### Patent Literature 1

JP-No. H09(1997)-236740

### Patent Literature 2

JP-No. H11(1999)-231209

1. An apodization filter having such light transmittance characteristics that an amount of transmitted light decreases gradually as it advances in a radial direction from a center of optical axis, wherein
a light-blocking mask layer having such light transmittance characteristics that an amount of transmitted light decreases gradually as it advances in a radial direction from a center of optical axis is formed on a surface of a flat transparent substrate at least having a light transmittance of 80% or higher using at least a dot pattern formed of a large number of dots, having a light transmittance of 20% or lower.

2. The apodization filter according to claim 1, wherein
the light-blocking mask layer has a configuration in which the number of dots in at least a circle region having a predetermined radius about the center of optical axis is set to zero.

3. The apodization filter according to claim 1, wherein
a width of the dots is selected in a range of 50 μm to 500 μm.

4. The apodization filter according to claim 1, wherein
the dots are selected to have the same shape and size.

5. The apodization filter according to claim 1, wherein
the dots are arranged randomly on a surface of the transparent substrate.

6. The apodization filter according to claim 1, wherein
a frosted black color is selected as the color of the dots.

7. A method of manufacturing an apodization filter having such light transmittance characteristics that an amount of transmitted light decreases gradually as it advances in a radial direction from a center of optical axis, comprising:
preparing a flat transparent substrate at least having a light transmittance of 80% or higher; and
forming a light-blocking mask layer having such light transmittance characteristics that an amount of transmitted light decreases gradually as it advances in a radial direction from a center of optical axis on a surface of the transparent substrate at least having a light transmittance of 80% or higher using at least a dot pattern formed of a large number of dots, having a light transmittance of 20% or lower.

8. The method of manufacturing the apodization filter according to claim 7, wherein
a width of the dots is selected in a range of 50 μm to 500 μm.

9. The method of manufacturing the apodization filter according to claim 7, wherein
the light-blocking mask layer is formed using a thin film forming process.

10. The method of manufacturing the apodization filter according to claim 9, wherein
the thin film forming process is a thin metal film forming process.

11. The method of manufacturing the apodization filter according to claim 7, wherein
the light-blocking mask layer is formed using an ink jet printing process.

12. The method of manufacturing the apodization filter according to claim 7, wherein
the light-blocking mask layer is formed using a silk printing process.
